(19) United States
(12) Patent Application Publication
(10) Pub. No.: US 2004/0195465 A1
(43) Pub. Date: Oct. 7, 2004

(54) CD case support method and apparatus

(76) Inventor: Alain Crouan, Le Mans (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/406,874

(22) Filed: Apr. 4, 2003

(51) Int. Cl. F16L 3/22

(52) U.S. Cl. 248/68.1

(57) ABSTRACT

The invention concerns a process for fastening a holding plate (10) for a digital optical disk on a support, and on the associated plate.

The plate comprises a rectangular backing (20) bearing, on a first surface (21) means for holding (22) the digital optical plate, and a rectangular peripheral casing (30) that rises from a second surface (23) of the backing (20) opposite to the first surface (21), the process of fastening comprising at least the following steps:

the plate (10) is placed in a loader (40), upright on a first side (31) of the casing (30),

positioning fingers (42a, 42b) temporarily move in as a support on a second side (32) of the casing (30) opposite to the first side (31) to hold the plate (10) in an upright position.

According to the invention, the second side (32) of the peripheral casing (30) of the plate (10) bears at least one groove (33) for locking the plate (10) in an upright position, into which the positioning fingers (42a, 42b) move in to engage.

In general, the invention relates to processes for fastening holding plates for digital optical disks onto a support, and the holding plates for digital optical disks.

More specifically, according to a first aspect, the invention relates to a process for fastening a holding plate for a digital optical disk onto a support; the plate comprises a rectangular backing that bears, on a first surface, means for fastening the digital optical disk and a rectangular peripheral casing that rises from a second backing surface opposite to the first surface; the process comprises at least the following steps:

The plate is placed in a loader, upright on a first side of the casing; positioning fingers then temporarily move in as a support on a second side of the casing opposite to the first side to maintain the plate in a vertical position.

According to a second aspect, the invention relates to a holding plate for digital optical disks; the plate comprises a rectangular backing that bears, on a first surface, means for holding the digital optical disk in place, a rectangular peripheral casing that rises from a second backing surface opposite to the first surface, and comprising at least a first and second side that are opposite to one another.

Processes of the type described above are known in prior art, in particular, for the high-speed fastening of plates onto printed cardboard supports.

The plates to be fastened are upright, lined up one behind the other in a loader tilted at about 10° in relation to the horizontal line, while the front plate is lower than the plates in the back. The front plate is held by a locking device.

The plates are taken one after another, beginning with the front plate, to be fastened onto supports. A gripping device equipped with a suction cup moves in to join together with the front plate then the locking device releases the line of plates, so that the front plate can be taken away by the gripping device.

In a parallel manner, the positioning fingers temporarily move in as a support on the upper side of the plate that is located immediately behind the front plate. In this way, the line of plates is held back and does not tip forward, even though the locking device is no longer holding it in place.

This process presents a flaw. The sides of the plate are narrow, and the positioning of the upper side of the plate in relation to the positioning fingers, must be assured with great precision to prevent the plate from tipping over, just because the fingers move in for support too far toward the edge or to one side of the plate. This great precision that has to be obtained is a major factor that limits the speeds it is possible to attain with the process of prior art.

These speeds are currently limited to about 5,000 plates fastened per hour and they cannot be increased, because this would lead to numerous stops of the manufacturing process because of plates that were improperly held back by the positioning fingers and that tipped over.

In this context, and according to a first aspect, the invention aims to propose a process that remedies the flaw mentioned above and to make it possible to increase production speeds.

To this end, the process of the invention, which also conforms to the generic definition given for it in the preamble above, is essentially characterized in that the second side of the peripheral casing of the plate bears at least one locking groove on the plate in the upright position, into which the positioning fingers move in to engage.

According to a second aspect, the invention aims to propose a plate that will likewise make it possible to remedy the flaw mentioned above and to increase the production speeds.

To this end, the plate of the invention, which also conforms to the generic definition given in the preamble above, is essentially characterized in that the second side of the peripheral casing of the plate bears at least one locking groove on the plate in the upright position, into which the positioning fingers move in to engage.

In one possible embodiment of the plate of the invention, the groove extends following the longitudinal direction of the second side of the peripheral casing.

Advantageously, the groove may extend over the whole length of the second side of the peripheral casing.

Preferably, the second side of the peripheral casing may bear two aligned longitudinal grooves, with each one extending over a fraction of the length of the second side.

For example, the groove may exhibit, on a plane transverse to the second side, a V-shaped profile.

Advantageously, on a plane transverse to the second side, the groove may exhibit a recessed semi-cylindrical profile.

Preferably, the maximum depth of the groove may range between 1/10 of a millimeter and one millimeter.

For example, the plate of the invention may bear grooves on the first and second sides of the peripheral casing.

Advantageously, the plate of the invention may bear grooves on three or four sides of the peripheral casing.

Other characteristics and advantages of the invention will become clearly evident from the description that is indicative, but not in any way limiting, given below with reference to the annexed Figures, among which:

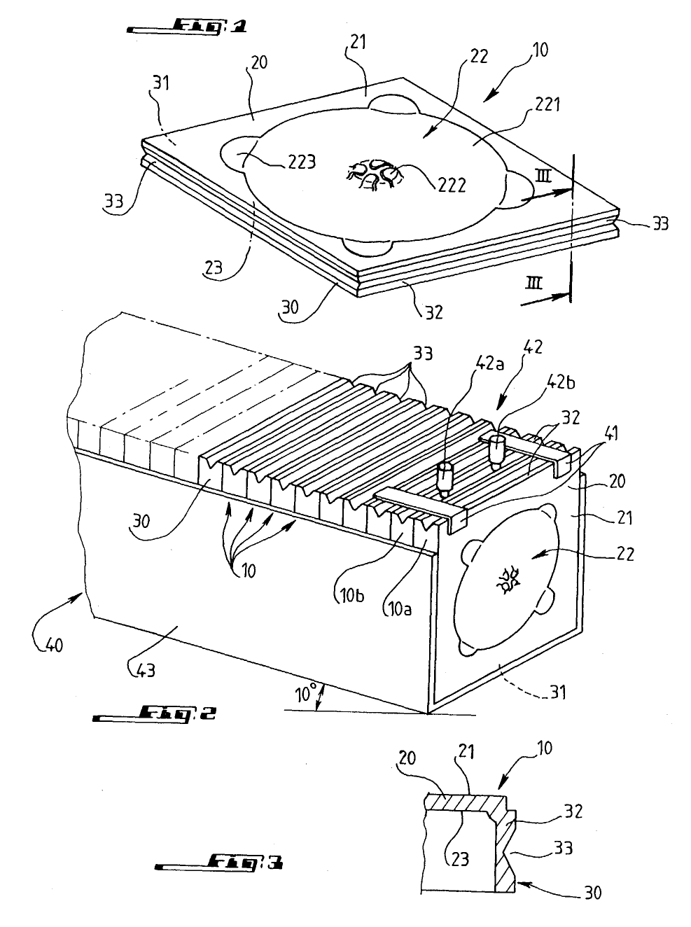

FIG. 1 is a view in perspective of a holding plate according to the invention,

FIG. 2 is a view in perspective of plates according to the invention arranged in a loader,

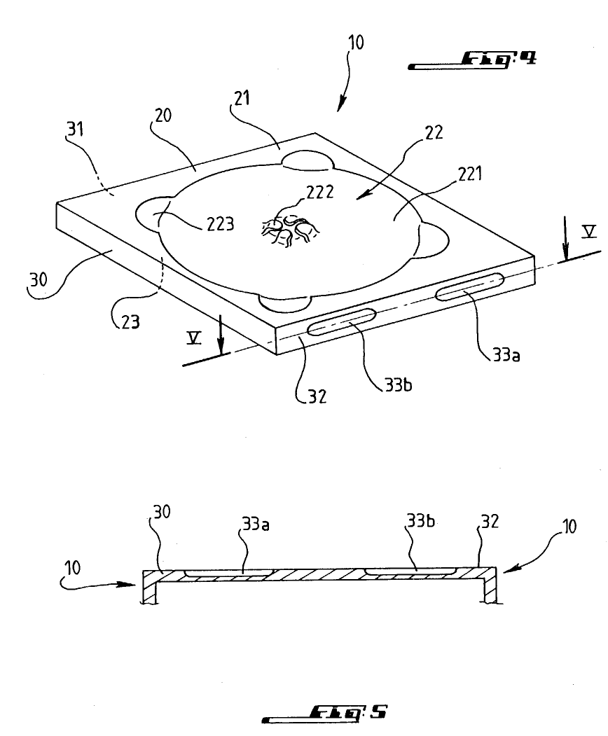

FIG. 3 is a partial cutaway view following arrows III of FIG. 1,

FIG. 4 is a view in perspective of another embodiment of a holding plate according to the invention, and

FIG. 5 is a partial cutaway view following arrows V of FIG. 4.

The invention, therefore, in a first aspect, relates to a process for fastening a holding plate 10 for digital optical disks, not represented, onto a support, [also] not represented.

Plate 10 comprises a rectangular backing 20, which bears, on a first surface 21, means 22 to hold the digital optical disk, and a rectangular peripheral casing 30 that rises from a second surface 23 of backing 20 opposite to the first surface 21.

The holding plate 10 is typically made of transparent molded plastic, such as polystyrene.

The holding means 22 comprise a circular recessed imprint 221, of a size corresponding to that of the disk, a rosette 222, into which the digital optical disk latches, recessed lugs 223 located on the periphery of the recessed imprint 221. The rosette 222 is located in the center of the recessed imprint. The digital optical disk moves in and latches by its center, [which is] hollowed out, on this rosette 222. The lugs allow the user to slip his finger under the disk attached to the rosette, in order to separate it [the disk] from the rosette.

The disk is typically a CD ROM, an audio CD or a DVD.

The support on which the holding plate 10 is attached is, for example, a printed cardboard cover.

The process for fastening holding plate 10 onto the support is known by one skilled in the art and will not be described in detail. To understand the invention, it suffices to specify that this process includes at least the following steps:

(a) Multiple holding plates 10 are placed in a loader 40, represented on FIG. 2; each plate is upright on a first side 31 of its peripheral casing 30. Plates 10 are arranged one behind the other, with the first surface 21 of a plate 10 being opposite to the second surface 23 of the adjacent plate 10.

Loader 40 is tilted 10° forward in relation to the horizontal line, the front being defined as the side of the loader 40 where a front plate 10a is located, in other words, the one that will be the first to be fastened onto the support.

Loader 40 includes a first selective locking device 41, mobile between its locking position where the device holds plates 10 in position on loader 40 and prevents them from tipping forward, and a release position where plates 10 are not held back.

Plates 10 are guided laterally on at least one side, for example by a vertical member 43 of loader 40.

(b) A gripping device with a suction cup, not represented, moves in and attaches itself to the front plate 10a. In a parallel manner, the first locking device 41, initially in its locking position, adopts its release position, and a second locking device 42 moves in to lock a second plate 10b located immediately behind plate 10a.

(c) The gripping device with a suction cup carries away the front plate 10a.

(d) The first locking device 41 moves from its release position to its locking position, the second locking device 42 releases the second plate 10b, and all of the plates move up one rank forward. The second plate 10b is then located in the position initially occupied by the front plate 10a, and the process resumes at step (a).

The second locking device 42 includes positioning fingers, for example, two fingers 42a and 42b, as represented on FIG. 2, which move in temporarily as a support on a second side 32 of the casing 30 opposite to the first side 31 in order the maintain the second plate 10b in an upright position.

These fingers 42a and 42b are typically vertical and they exhibit one free semi-cylindrical extremity, with an approximate radius of 1.2 millimeters.

According to the invention, the second side 32 of the peripheral casing 30 of each plate 10 bears at least one locking groove 33 of the plate 10 in an upright position, into which positioning fingers 42a and 42b move in to engage.

This groove 33 extends and continues in the longitudinal direction of the second side 32 of the peripheral casing 30.

In a first embodiment, represented in FIG. 1, the groove 33 extends over the whole length of the second side 32 of peripheral casing 30. Fingers 42a and 42b are thus engaged into the same groove 33.

In a second embodiment, represented on FIGS. 4 and 5, the second side 32 of the peripheral casing 30 bears two aligned, longitudinal grooves 33a and 33b, with each one extending over a fraction of the length of the second side 32. Fingers 42a and 42b, in this case, are engaged in different grooves, grooves 33a and 33b respectively.

The second side 32 of casing 30 exhibits, in this second embodiment, better mechanical resistance than in the first embodiment. Indeed, there is less material withdrawn, and the material withdrawn does not form a continuous band, with such a band constituting a line of least resistance.

In contrast, the molds necessary for the manufacture of the plates according to the second embodiment are slightly more complex and more costly.

As can be seen on FIGS. 4 and 5, the longitudinal extremities of grooves 33a and 33b are rounded in the plane into which the second side 32 extends, and they are likewise rounded in the longitudinal plane perpendicular to the aforesaid plane, both for esthetic reasons and for reasons of mechanical resistance.

Groove 33, or grooves 33a and 33b, in a plane transverse to the second side 32, exhibits a V-shaped profile.

According to a variant embodiment, groove 33, or grooves 33a and 33b, exhibits, in a plane transverse to the second side 32, a recessed semi-cylindrical profile with a radius corresponding to the radius of the free semi-cylindrical extremities of positioning fingers 42a and 42b.

The axes of the half cylinders constituting the free extremities of positioning fingers 42a and 42b are parallel to the longitudinal direction of the second side 32.

These grooves 33, 33a and 33b are arranged in the mass of casing 30.

In a variant embodiment, it is the whole of casing 30 that may form the groove, with the casing 30 then exhibiting a recess on a first surface and a protrusion on a second surface opposite to the first.

The V-shaped profile allows for very precise positioning of positioning fingers 42a and 42b, because the contact between the free extremities of these fingers and the two surfaces of the groove or grooves is made along two parallel lines only.

The semi-cylindrical profile makes it possible to obtain a less precise positioning, because the entire surface of the free extremities of positioning fingers 42a and 42b is in contact with the surface of the groove or grooves. Irregularities on these surfaces may interfere with the positioning. In contrast, the semi-cylindrical profile makes it possible to more effectively maintain the fingers inside the grooves, because the slope that has to be cleared for the finger to come out of the groove, is greater.

The maximum depth of groove 33 or grooves 33a and 33b ranges between 1/10 of a millimeter and one millimeter, depending on the thickness of casing 30. It is typically 0.5 millimeters.

The transverse width of the sides of casing 30 is approximately four millimeters, and the transverse width of groove 33 or grooves 33a and 33b is approximately two millimeters.

Plates 10 exhibit a square or rectangular shape.

Casing 30 bears grooves 33, 33a, 33b on one side only, on two sides, three sides or even four sides.

The grooves of the four sides make it possible to arrange plates 10 in loader 40 with any side whatsoever oriented toward fingers 42a and 42b. This is particularly advantageous in the case of square plates, since they present four perfectly identical sides.

Grooves on two opposite sides are very well adapted to symmetrical rectangular plates in relation to a median axis.

The same side of the casing 30 may bear more than two grooves identical to grooves 33a and 33b, for example, three or four, depending on the number of positioning fingers on the second locking device 42.

The invention applies to holding plates made of materials other than a transparent plastic, and to plates made with processes other than molding.

Therefore, it is possible to conceive that the process of the invention makes it possible to effectively keep the plate in an upright position, with the positioning finger being engaged in a groove where it is difficult for it to slip out. The likelihood that the finger would be poorly positioned and that the plate would tip is greatly diminished, and the production speeds can be significantly increased.

1. Process of fastening a holding plate (10) for a digital optical disk onto a support, the plate comprising a rectangular backing (20), bearing on a first surface (21) means (22) for holding the digital optical disk, and a rectangular peripheral casing (30) that rises from a second surface (23) of the backing (20) opposite to the first surface (21), the process comprising at least the following steps:
plate (10) is placed into a loader (40), upright on a first side (31) of the casing (30),
positioning fingers (42a, 42b) temporarily move in as a support on a second surface (32) of the casing (30) opposite to the first side (31) to hold the plate (10) in an upright position, characterized by the fact that the second side (32) of the peripheral casing (30) of the plate (10) bears at least one groove (33, 33a, 33b) for locking the plate (10) in an upright position, into which the positioning fingers (42a, 42b) move in to engage.

2. Holding plate for an digital optical disk, the plate (10) comprising a rectangular backing (20) bearing, on a first surface (21), means (22) for holding the digital optical disk, and a rectangular peripheral casing (30) that rises from a second surface (23) of the backing (20) opposite to the first surface (21), and comprising at least a first and a second side (31, 32), opposite to one another, characterized in that the second side (32) of the peripheral casing (30) of the plate (10) bears at least one groove (33, 33a, 33b) for locking the plate (10) in an upright position.

3. Plate according to claim 2, characterized in that the groove (33, 33a, 33b) extends following the longitudinal direction of the second side (32) of the peripheral casing (30).

4. Plate according to claim 3, characterized in that the groove (33) extends over the whole length of the second side (32) of the peripheral casing (30).

5. Plate according to claim 3, characterized in that the second side (32) of the peripheral casing (30) bears two aligned longitudinal grooves (33a, 33b), each extending over a fraction of the length of the second side (32).

6. Plate according to any one of claims 2 to 5, characterized in that the groove (33, 33a, 33b) exhibits, in a plane transverse to the second side (32), a V-shaped profile.

7. Plate according to any one of claims 2 to 5, characterized in that the groove (33, 33a, 33b) exhibits, in a plane transverse to the second side (32), a recessed semi-cylindrical profile.

8. Plate according to any one of claims 2 to 7, characterized in that the maximum depth of the groove (33, 33a, 33b) ranges between 1/10 of a millimeter and one millimeter.

9. Plate according to any one of claims 2 to 8, characterized in that it bears grooves (33, 33a, 33b) on the first and the second side (31, 32) of the peripheral casing (30).

10. Plate according to any one of claims 2 to 8, characterized in that it bears grooves (33, 33a, 33b) on three or four sides of the peripheral casing (30).
